(19) United States
(12) Patent Application Publication
(10) Pub. No.: US 2024/0320014 A1
(43) Pub. Date: Sep. 26, 2024

(54) METHOD, APPARATUS, DEVICE, AND STORAGE MEDIUM FOR MESSAGE PROCESSING

(71) Applicant: Beijing Zitiao Network Technology Co., Ltd., Beijing (CN)

(72) Inventors: Xinchen Tang, Beijing (CN); Yuxuan Zhao, Beijing (CN); Yuchen Peng, Beijing (CN); Ge Zhang, Beijing (CN)

(21) Appl. No.: 18/574,623

(22) PCT Filed: Oct. 19, 2022
(86) PCT No.: PCT/CN2022/126180

§ 371 Date: Dec. 27, 2023

(30) Foreign Application Priority Data
Oct. 22, 2021 (CN) 202111232529.2

(51) Int. Cl. G06F 9/451; G06F 3/0483

(52) U.S. Cl. CPC G06F 9/451; G06F 3/0483

(57) ABSTRACT

Embodiments of the present disclosure discloses a method, apparatus, a device, and a storage medium for message processing. The method includes: displaying a received predetermined message in a conversation interface; in response to determining that the current user triggers jumping to a detail interface of the predetermined message and returns to the conversation interface, determining whether a predetermined condition is satisfied; and in response to a determining result that the predetermined condition is satisfied, displaying, in the conversation interface, at least one shortcut operation control corresponding to the predetermined message.

### CROSS-REFERENCE TO RELATED APPLICATION

This application claims priority to Chinese Patent Application No. 202111232529.2, filed on Oct. 22, 2021, the entire contents of which are incorporated herein by reference in its entirety.

### FIELD

Embodiments of the present disclosure relate to the field of computer technologies, and for example relate to a method, apparatus, a device, and a storage medium for message processing.

### BACKGROUND

With the rapid development of Internet technologies and terminal technologies, information interaction between users is becoming more and more convenient. The conversation function has become one of the necessary functions in many terminals or applications, and users can perform related processes, such as replying or forwarding, to conversation messages in a conversation interface.

### SUMMARY

Embodiments of the present disclosure provides a message processing method and apparatus, a storage medium, and a device, which can optimize message processing solutions in the related art.

In a first aspect, embodiments of the present disclosure provide a message processing method, which includes:
displaying a received predetermined message in a conversation interface;
determining whether a predetermined condition is satisfied in response to determining that the current user triggers jumping to a detail interface of the predetermined message and returns to the conversation interface; and
displaying at least one shortcut operation control corresponding to the predetermined message in the conversation interface in response to a determining result that the predetermined condition is satisfied.

In a second aspect, embodiments of the present disclosure provide a message processing apparatus, which includes:
a message displaying module, configured to display a received predetermined message in a conversation interface;
a determining module, configured to determine whether a predetermined condition is satisfied in response to determining that the current user triggers jumping to a detail interface of the predetermined message and returns to the conversation interface; and
a control displaying module, configured to display at least one shortcut operation control corresponding to the predetermined message in the conversation interface in response to a determining result that the predetermined condition is satisfied.

In a third aspect, embodiments of the present application provide an electronic device, which includes: a memory, a processor, and a computer program stored on the memory and executable on the processor, wherein the processor, when executing the computer program, implements the method according to embodiments of the present disclosure.

In a fourth aspect, embodiments of the present disclosure provide a computer-readable storage medium on which a computer program in stored, wherein the program, when executed by a processor, causes the message processing method according to embodiments of the present disclosure to be implemented.

### BRIEF DESCRIPTION OF THE SEVERAL VIEWS OF THE DRAWINGS

FIG. 1 is a schematic flowchart of a message processing method according to embodiments of the present disclosure;

FIG. 2 is a schematic flowchart of another message processing method according to embodiments of the present disclosure;

FIG. 3 is a schematic diagram of an interaction process of a message processing method according to embodiments of the present disclosure;

FIG. 4 is a schematic flowchart of yet another message processing method according to embodiments of the present disclosure;

FIG. 5 is a schematic diagram of an interaction process of yet another message processing method according to embodiments of the present disclosure;

FIG. 6 is a structural block diagram of a message processing apparatus according to embodiments of the present disclosure; and

FIG. 7 is a structural block diagram of an electronic device according to embodiments of the present disclosure.

### DETAILED DESCRIPTION

It should be understood that various steps documented in method embodiments of the present disclosure may be performed in a different order, and/or in parallel. In addition, the method embodiments may include additional steps and/or omit performing the illustrated steps. The scope of the present disclosure is not limited in this regard.

As used herein, the term “including” and variations thereof is open-ended, i.e., “including but not limited to”. The term “based on” is “at least partially based on”. The term “one embodiment” means “at least one embodiment”; the term “another embodiment” means “at least one another embodiment”; and the term “some embodiments” means “at least some embodiments”. Relevant definitions of other terms will be given in the following description.

It should be noted that the concepts of “first” and “second” mentioned in the present disclosure are only used to distinguish different devices, modules, or units, and are not used to limit the order or interdependence of the functions performed by these devices, modules, or units.

It should be noted that the modifications “one” and “a plurality of” as mentioned in the present disclosure are illustrative and not restrictive; and those skilled in the art should understand that, unless otherwise specified in the context, they should be understood as “at least one”.

The names of the messages or information exchanged between a plurality of apparatuses in embodiments of the present disclosure are for illustrative purposes only and are not intended to limit the scope of these messages or information.

For the following embodiments, each embodiment simultaneously provides optional features and examples, the various features described in the embodiment may be combined to form a plurality of optional solutions, and each numbered embodiment should not be regarded as only one technical solution.

Currently, in order to improve the message processing efficiency, shortcut processing functions can be provided to users. For example, when receiving a message sent by the other party, the shortcut reply content such as a text that the user may reply to the message is displayed in the conversation interface by default for the user to directly select and send to the other party.

However, according to implementation solutions of the shortcut processing function in the related art, the shortcut reply content displayed on the conversation interface will occupy a great display space and cause much interference to users. Thus, the related art is not perfect and needs to be improved.

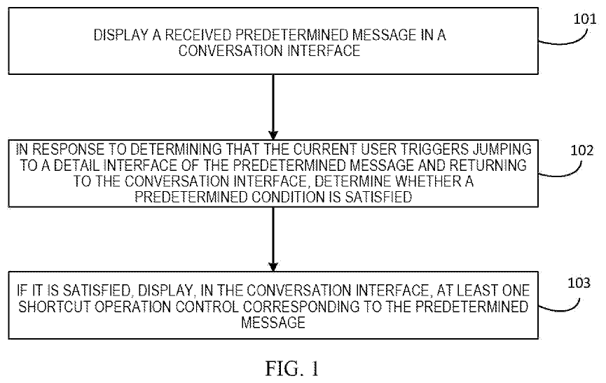

FIG. 1 is a schematic flowchart of a message processing method according to embodiments of the present disclosure. The method may be performed by a message processing apparatus, wherein the apparatus may be implemented by software and/or hardware and may generally be integrated in an electronic device. The electronic device may be a mobile device such as a cell phone, a smartwatch, a tablet, and a personal digital assistant; or it may be other devices such as a desktop computer. As shown in FIG. 1, the method includes following steps.

At Step S101: a received predetermined message is displayed in a conversation interface.

In embodiments of the present disclosure, the conversation interface may be a interface in a predetermined application, the predetermined application may provide a conversation function and may be installed in an electronic device, and the user may register an account in the predetermined application and log in. The conversation may include an instant messaging conversation and may include a one-to-one conversation or a group conversation, etc., and users participating in the conversation may send conversation messages to each other. The conversation interface may be configured to display a conversation message. The conversation message is referred to as a message, and the form of the content contained within the message is not limited. That is, the message type of the predetermined message is not limited, and may include, for example, text, symbols, emoticon icons, pictures, audio or video. Upon receiving a message sent by a conversation participant via the predetermined application, the message can be displayed on the conversation interface for the current user to view and perform relevant processing on the conversation message, such as replying or forwarding. The displaying manner of the message may match the form of the message content, and the massage may be displayed as text, symbols, emoticon icons, thumbnails of pictures, playback controls for audio messages, video covers for video messages, and so on.

It should be noted that the predetermined message in this step may be any of the received messages in the conversation interface, a currently received latest message, or a historically received message, which is not limited herein.

At Step 102: if it is determined that the current user triggers jumping to a detail interface of the predetermined message and returning to the conversation interface, it is determined whether a predetermined condition is satisfied.

In the related art, in order to improve the message processing efficiency, shortcut processing functions can be provided to users. For example, when receiving a message sent by the other party, the shortcut reply content such as a text that the user may reply to the message is displayed in the conversation interface by default for the user to directly select and send to the other party. However, the shortcut reply content displayed on the conversation interface may take up a lot of display space, and users may not want to process messages with the shortcut reply content provided by default, which may cause excessive interference to the user and waste valuable display space on the conversation interface.

In embodiments of the present disclosure, after displaying the predetermined message, whether the current user has viewed the predetermined message can be determined by determining whether the current user triggers jumping to a detail interface of the predetermined message and returns to the conversation interface In the case of determining that the message has been viewed by the user, whether it is necessary to display a shortcut operation control for performing a shortcut operation on the predetermined message can be determined based on the predetermined condition. Compared to the related art of displaying the message while displaying the relevant content for performing a shortcut operation on the message by default, the logic for determining whether the message has been read and whether the predetermined condition is met is added, which can avoid excessive interference to the user brought about by directly displaying the shortcut operation control and save the display space in the conversation interface to a certain extent.

For example, when displaying the predetermined message in the conversation interface, not all of the message content may be displayed, and what is displayed may for example be a portion of the text, a thumbnail of a picture, a playback control for an audio message, or a video cover for a video message, and so on. The user can view the message details by entering further predetermined viewing operations, for example, the user may double-click on part of the text to view all of the text, click on the thumbnail of the picture to view the original or enlarged picture, click on the playback control of the audio message to listen to the audio content or trigger the speech-to-text function to view the speech content in text, or click on the video cover of the video message to view the video that is being played, and so on. The interface for displaying the detail information of the message may be referred to as a detail interface, in which all text, raw pictures, speech content in text, and video content as described above may be displayed. For example, jumping to the detail interface may be triggered by inputting a predetermined viewing operation as described above, and the form of the predetermined viewing operation is not limited and may for example be clicking, double-clicking, or long-pressing. After viewing the message details on the detail interface, the user may exit the detail interface and return to the conversation interface by, for example, triggering a detail interface closing button.

For example, the predetermined condition may be used to indicate that the current user is interested in the predetermined message, and there is a need to reply or otherwise process the predetermined message, and the content of the predetermined condition may be configured according to the actual situation. For example, it is determined that a predetermined condition is satisfied when determining that the current user's attention value for the predetermined message is in a predetermined range. The attention value herein is used to characterize the degree of attention of user to the predetermined message.

At Step 103: in response to a determining result that the predetermined condition is satisfied at least one shortcut operation control corresponding to the predetermined message is displayed in the conversation interface.

For example, at least one shortcut operation control corresponding to the predetermined message is displayed in the conversation interface in a case of determining that the predetermined condition is satisfied. The shortcut operation control can be understood as a control that can quickly complete the corresponding operations via a single trigger or a limited number of operations after a single trigger, which does not require the user to find the corresponding operation entrance and carry out the relevant operations through plural steps of complex operations. The limited number of operations can be understood as that the number of operations is less than or equal to a predetermined number threshold, and the predetermined number threshold can be, for example, 2. Taking an emoticon reply as an example, the conventional emoticon reply operation process in the related art generally includes that: the user triggers a reply to the message by long-pressing the message to enable an input box to pop up, and then triggers the display of an emoticon selection interface; then, the user finds the emoticon icon that he or she wants to send and clicks on it from the emoticon selection interface; afterwards, the selected emoticon icon appears in the input box, and the user clicks the send button to complete the emoticon reply. Thus, as shown, the operation process is complicated and inefficient. In embodiments of the present disclosure, the shortcut operation control may include a shortcut emoticon reply control (referred to as an emoticon control). The emoticon control may directly display the emoticon selection interface after being triggered, and when the user triggers a certain emoticon icon, the reply is made directly with the emoticon icon; alternatively, the emoticon control can directly display an emoticon icon, and a reply is directly made with the emoticon icon after the emoticon control is triggered.

The aforesaid emoticon controls are only for illustrative purposes, and the shortcut operation controls in embodiments of the present disclosure are not limited to the shortcut emoticon reply controls as mentioned above. For example, the at least one shortcut operation control includes a shortcut processing control which is configured to process the predetermined message with a predetermined function and/or a shortcut reply control which is configured to reply to the predetermined message. The processing of the predetermined function may include, for example, saving, marking or forwarding, and the like. Accordingly, the shortcut processing control may include a shortcut saving control, a shortcut marking control and a shortcut forwarding control, and the like. The shortcut reply control may include a shortcut emoticon reply control, a shortcut text reply control (referred to as a text control), a shortcut picture reply control (referred to as a picture control), a shortcut video reply control (referred to as a video control), and a shortcut voice reply control (referred to as an audio control), and so on.

For example, the number of the at least one shortcut operation control as displayed and the type of the control may be pre-set, and may be the same or different for different messages, which is not limited herein.

Alternatively, the at least one shortcut operation control corresponding to the predetermined message is displayed in an association range of the predetermined message in the conversation interface. For example, a distance between a display region corresponding to the association range and a display region of the predetermined message is less than a predetermined distance threshold.

Alternatively, after displaying the at least one shortcut operation control corresponding to the predetermined message, the method may further include performing a corresponding shortcut operation in response to receiving a trigger operation for the target shortcut operation control. It should be noted that the target shortcut operation control is a shortcut operation control selected by the current user from the at least one shortcut operation control corresponding to the displayed predetermined message.

In the message processing method according to embodiments of the present disclosure, a received predetermined message is displayed in a conversation interface, whether a predetermined condition is satisfied is then determined in a case of determining that the current user triggers jumping to a detail interface of the predetermined message and returns to the conversation interface, and finally at least one shortcut operation control corresponding to the predetermined message is displayed in the conversation interface in response to a determining result that the predetermined condition is satisfied. By adopting the above-mentioned technical solution, after displaying the received predetermined message in the conversation interface, if the current user triggers to enter the detail interface of the message and returns to the conversation interface, it means that the current user has already viewed the predetermined message. Then, whether it is necessary to display the shortcut operation control is determined based on the predetermined condition, and the shortcut operation control is displayed when necessary, which can provide the user with a message shortcut-processing function, avoid excessive interference to the user as caused by displaying the shortcut operation control by default while displaying the message, and utilize the display space of the conversation interface more reasonably and effectively.

In some embodiments, determining whether the predetermined condition is satisfied includes determining whether the predetermined condition is satisfied based on target data. The target data herein includes first data and/or second data, the first data includes data as generated by a message content of the predetermined message when the detail interface is viewed by the current user, and the second data includes data corresponding to the message content of the predetermined message. The advantage of such a configuration is that whether it is necessary to display the shortcut operation control can be determined more reasonably and accurately.

For example, the data generated by the message content of the predetermined message during the process of being viewed by the current user on the detail interface may include data such as the display duration of the message content on the detail interface, control operations or interactive operations input by the current user on the detail interface in response to the predetermined message, and other related data. The data corresponding to the message content of the predetermined message may, for example, include data related to the content itself such as the type of the message content (i.e., the message type of the predetermined message) or the subject.

In some embodiments, determining whether the predetermined condition is satisfied based on the target data includes: inputting the target data into a predetermined model configured to determine the current user's attention value for the message, determining whether the attention value is in a predetermined range according to an output result of the predetermined model, and determining that a predetermined condition is satisfied in response to that the attention value falls into the predetermined range. The advantage of such a configuration is that the current user's attention value for the message can be determined more accurately by the model, such that whether to display the shortcut operation control can be determined more reasonably.

For example, the predetermined model can be obtained by training a neural network model with training sample data, and the neural network model may be adopted to deal with imprecise and ambiguous information processing problems that require the simultaneous consideration of many factors and conditions. Thus, an accurate predetermined model can be obtained by training the predetermined neural network model, so as to more reasonably determine the current user's attention value for the message. The training sample data herein may include sample data as generated by the message content of different messages during the process of being viewed by different sample users on the detail interface, and label data for the attention value of different sample users for different messages corresponding to each sample data. The label data may be designed according to the model accuracy for measuring the attention value, and may for example include 0 and 1 or 0, 1, and 2. For example, the larger the value, the higher the degree of attention of user. When adopting the predetermined model, the output result of the predetermined model may be information such as the confidence level of each label. In a case where the label data includes 0, 1, and 2, assuming that the output result is 1, or 1 has the highest confidence level, the attention value may be determined to be 1, and it may be determined that the predetermined condition is satisfied if the predetermined range may be, for example, greater than or equal to 1.

For example, the predetermined model can be obtained by training in the following manner: obtaining training sample data; inputting the training sample data to the predetermined neural network model, and calculating a corresponding predetermined loss function; and training the predetermined neural network model based on the predetermined loss function to obtain the predetermined model.

In some embodiments, the first data includes at least one of following items: a display duration, a number of times of display and a displayed proportion of the message content of the predetermined message on the detail interface; an operation type and/or an operation result of a display controlling operation performed by the current user on the detail interface to the message content of the predetermined message; and an operation type and/or an operation result of an interactive operation performed by the current user based on the message content of the predetermined message on the detail interface. The advantage of such a configuration is that whether it is necessary to display the shortcut operation control can be determined more accurately.

The display duration of the message content of the predetermined message on the detail interface may be determined based on the time interval between the time that the user triggers jumping to the detail interface of the predetermined message and the time that the user returns to the conversation interface. The number of times of display may be, for example, the number of times the message is displayed in the detail interface, such as the number of times the video is played; and the number of times of display can also be the number of times the current user triggers jumping to the detail interface of the predetermined message. The displayed proportion may be a ratio of the message content as displayed to the total message content; and for example for a video message, it may be a ratio of the played duration to the total duration of the video.

For example, the display controlling operation on the message content of the predetermined message can be understood as an operation to adjust the display method of the message content, and the operation type can be determined according to the message type of the predetermined message. When the user performs the display controlling operation on the message content, it may indicate that the user needs to view the message content in accordance with his or her own wishes (possibly, the user needs to view more details of the content, or to view repeatedly and the like), which may to a certain extent reflect user's attention value for the message. Therefore, by taking the relevant data as target data, whether satisfying the predetermined condition can be determined more accurately.

Alternatively, the message type of the predetermined message includes a picture, and an operation type of the display controlling operation includes at least one of zooming in, zooming out, and dragging. Accordingly, the operation result of the display controlling operation includes at least one of a zoom-in ratio, a zoom-out ratio, a dragging direction and a dragging distance.

Alternatively, the message type of the predetermined message includes a video, and the operation type of the display controlling operation includes at least one of pause, play back and progress adjustment. Accordingly, the operation result of the display controlling operation includes at least one of a number of times of pause, a pause duration, a number of times of playback, and a number of times of rewinding in a progress bar.

For example, the interactive operation based on the message content of the predetermined message may be understood as an operation for interaction inputted for the message content. Alternatively, the predetermined message includes interactable content, and the interactive operation based on the message content of the predetermined message includes interactive operations directed to the interactable content and/or a creator of the interactable content. The interactable content herein means that the content displayed in the detail interface of the predetermined message can be subject to an interactive operation, such as an interactive operation of liking, commenting, following, and the like. For example, the interactable content may be a forwarding content, the forwarding content is a multimedia content such as a video, the interactive operation for the interactable content may be triggering the like control on the detail interface, and the interactive operation for the creator of the interactable content may be triggering the follow control of the creator, and the like.

In some embodiments, displaying in the conversation interface at least one shortcut operation control corresponding to the predetermined message includes: displaying in the conversation interface at least one shortcut operation control corresponding to the predetermined message and associated with the current user. The advantage of such a configuration is that the display of the shortcut operation control can be personalized for the current user, which is more suitable for the operation needs of the current user.

For example, there may be a variety of shortcut operation controls available for display, which may constitute a collection of shortcut operation controls, and at least one shortcut operation control may be determined from the collection of shortcut operation controls to be displayed according to the historical operations of the current user.

For example, there may be a plurality of shortcut operation controls of the same type or realizing the same function, and the shortcut operation control that is most suitable for the current user may be selected for display. Taking an emoticon icon as an example, an emoticon icon for expressing praise may include a heart icon, a heart-giving icon, an applauding icon, and a thumbs-up icon, etc., and the shortcut operation control corresponding to the heart icon that has been used the most times in the history of the current user may be displayed according to the history usage habits of the current user under the current user's authorization.

In some embodiments, the shortcut reply control includes an emoticon control; after displaying at least one shortcut operation control corresponding to the predetermined message in the conversation interface, the method further includes: in response to receiving a trigger operation for a target emoticon control, displaying the predetermined message in association with the emoticon icon corresponding to the target emoticon control in the conversation interface for updating the display of the predetermined message. The advantage of such a configuration is that the display of the predetermined message can be updated by utilizing the emoticon icon as replied by user, which highlights the interaction result, implements the display in a novel form, enhances the interactivity between users participating in the conversation, enhances the fun of the conversation interaction, and improves the interaction effect. Alternatively, there is an intersection between the display region of the emoticon icon and the display region of the predetermined message.

In some embodiments, the target data further includes second data, and the second data includes: a target content type corresponding to the message content of the predetermined message, and data generated by historical content of the target content type in the process of being viewed by the current user. The advantage of such a configuration is that whether the predetermined condition is satisfied can be determined more accurately.

For example, the data generated by historical content of different content types during the process of being viewed by the current user may be obtained under the user's authorization. The historical content may include message content of historical messages in a conversation, and may also include content that is published by a content publisher in a predetermined application and is available for viewing by all users, such as a photo or a video, and the like. Based on the aforesaid data, it is possible to understand the current user's attention value for the content type of the predetermined message, which in turn facilitates determining the current user's attention value for the predetermined message more accurately.

In some embodiments, when the conversation interface is a group conversation interface with a predetermined topic, the target data further includes third data, and the third data includes data generated by the predetermined message in a process of being viewed by a predetermined user within a group, the predetermined user not including the current user. The advantage of such a configuration is that for the group conversation with a certain topic, whether the predetermined condition is met can be determined more accurately.

For example, the predetermined topic may be determined based on the name of the group, such as “XX company fall travel group” or “XX fan group” and the like. In the group, the conversation members usually interact with the message around the topic, and if it is determined that a certain number of members are interested in the message according to the third data, it can reflect that the current user may also be interested in the message, such that the dimension of the target data can be enhanced and the shortcut operation control can be displayed in a more reasonable manner. The predetermined user herein may include all or some of users other than the current user, and furthermore generally does not include the user who sends the predetermined message. Alternatively, the third data may include a cumulative number of times the predetermined user has triggered the shortcut operation control during a process in which the predetermined message has been viewed by the predetermined user within the group.

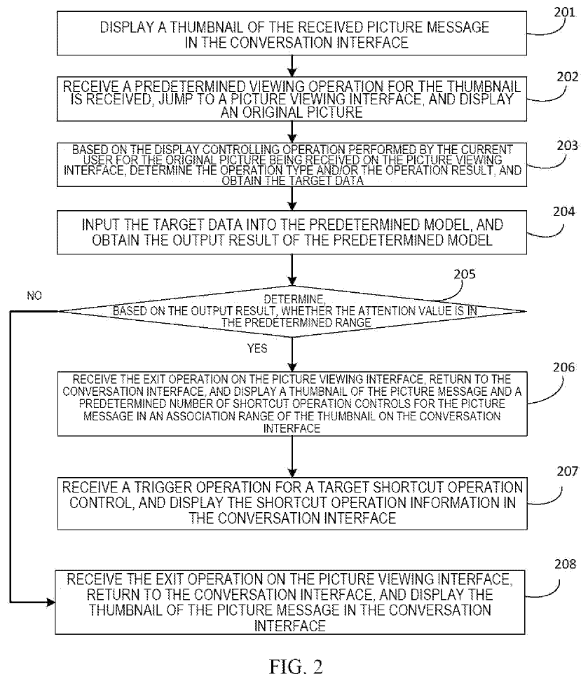

FIG. 2 is a schematic flowchart of another message processing method according to embodiments of the present disclosure. The embodiments of the present disclosure are refined embodiments on the basis of each of the optional solutions in the aforesaid embodiments. Taking the predetermined message being a picture message as an example, the method includes following steps.

At Step 201: a thumbnail of the received picture message is displayed in the conversation interface.

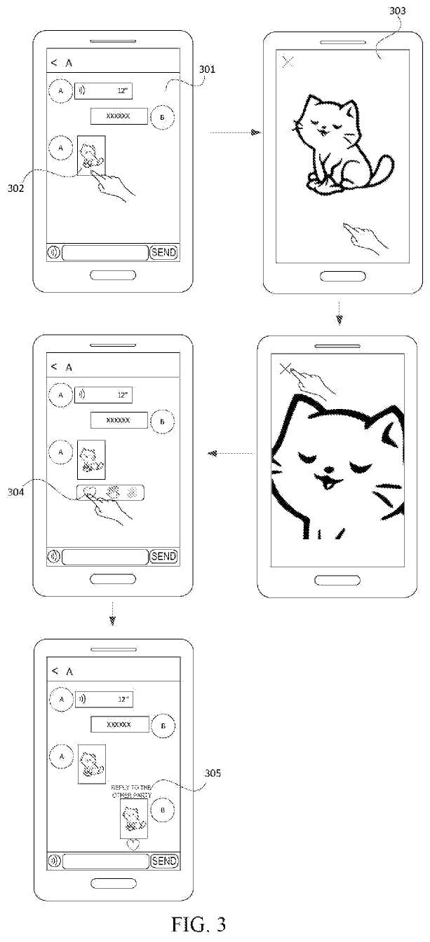

FIG. 3 is a schematic diagram of an interaction process of a message processing method according to embodiments of the present disclosure. As shown in FIG. 3, user A sends a picture message to user B (the current user), the picture content is a kitten, and a thumbnail 302 of the picture is displayed in the conversation interface 301.

At Step 202: a predetermined viewing operation for the thumbnail is received, a picture viewing interface is jumped to, and an original picture is displayed.

For example, the picture viewing interface may be understood as a detail interface of the picture message, and the predetermined viewing operation may be understood as an operation that triggers jumping to the detail interface, which may be, for example, clicking on a thumbnail. As shown in FIG. 3, after user B clicks on the thumbnail of the picture message, he/she enters a picture viewing interface 303, in which the original picture of the picture message can be displayed in full screen, thereby facilitating the user to view the contents of the picture more clearly.

At Step 203: based on the display controlling operation performed by the current user for the original picture being received on the picture viewing interface, the operation type and/or the operation result is determined, and the target data is obtained.

For example, the type of display controlling operation may, for example, include at least one of zooming in, zooming out, and dragging. As shown in FIG. 3, assuming that user B sees that the expression of the kitten is rather adorable and wants to take a closer look at it, he/she can realize the zoom-in operation on the original picture by inputting an operation such as a two-finger reverse swiping, and the operation result can include data such as the zoom-in ratio.

At Step 204: the target data is input into the predetermined model, and the output result of the predetermined model is obtained.

For example, after inputting the target data into the predetermined model, the predetermined model may output an output result for indicating the current user's attention value for the picture message.

At Step 205: it is determined, based on the output result, whether the attention value falls into the predetermined range; step 206 is performed if yes; and step 208 is performed if no.

At Step 206: the exit operation is received on the picture viewing interface, the conversation interface is returned to, and a thumbnail of the picture message and a predetermined number of shortcut operation controls for the picture message in an association range of the thumbnail are displayed on the conversation interface.

For example, if it is determined that the current user has a high attention value for the picture message, it may indicate that the current user is likely to have a need for shortcut operations on the picture message. Therefore, a predetermined number of shortcut operation controls may be displayed in an association range of the thumbnail while the thumbnail is displayed.

As shown in FIG. 3, after user B closes the picture viewing interface, he/her returns to the conversation interface, and while the thumbnail 302 is displayed, three shortcut operation controls, all of which are shortcut reply emoticon controls, are displayed below the thumbnail.

At Step 207: a trigger operation for a target shortcut operation control is received, and the shortcut operation information is displayed in the conversation interface.

For example, as shown in FIG. 3, after clicking on the heart control 304, user B can quickly reply to the kitten picture sent by user A, and a shortcut reply message 305 is displayed on the conversation interface. The shortcut reply message 305 may include a text prompt for indicating the reply, a reference message to the picture message, and an emoticon icon replied by user B.

At Step 208: the exit operation is received on the picture viewing interface, the conversation interface is returned to, and the thumbnail of the picture message is displayed in the conversation interface.

For example, if user B does not perform the display controlling operation after entering the message viewing interface, the attention value may be low and goes beyond the predetermined range. Thus, there is no need to display the shortcut operation control after exiting the picture viewing interface, so as to avoid too much interference to user B and meanwhile save the display space of the conversation interface.

In the message processing method according to an embodiment of the present disclosure, while displaying the picture in a picture viewing interface of the picture message, the data related to the display controlling operation for the picture as generated during the process of the picture being viewed by a user can be obtained, and the user's attention value for the picture message can be determined based on the data and a predetermined model; when it is determined that the user is interested, a shortcut operation control is displayed after exiting the picture viewing interface, which is convenient for the user to quickly respond to the message or perform related processing; and when it is determined that user's attention value is low, the interference to the user as caused by displaying the shortcut operation control can be avoided, so as to utilize the display space of the conversation interface more reasonably and efficiently.

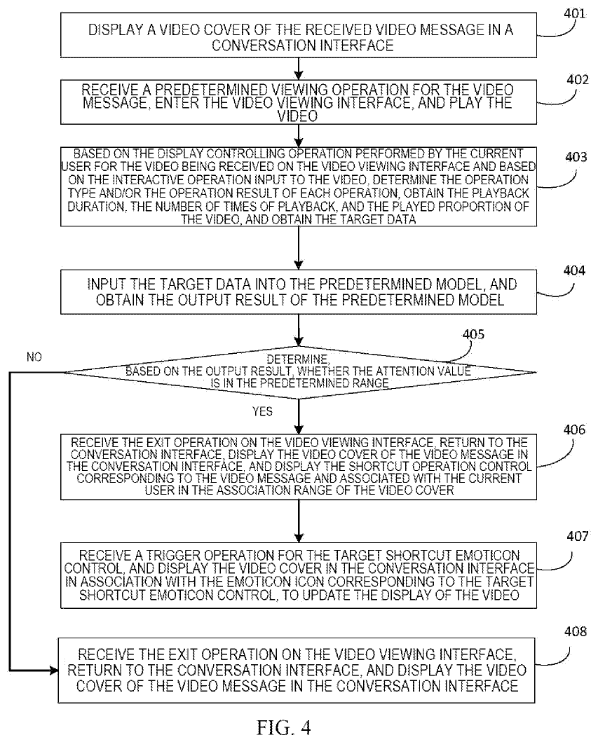

FIG. 4 is a schematic flowchart of yet another message processing method according to embodiments of the present disclosure. The embodiments of the present disclosure are refined embodiments on the basis of each of the optional solutions in the aforesaid embodiments. Taking the message being a video message as an example, the method includes following steps.

At Step 401: a video cover of the received video message is displayed in a conversation interface.

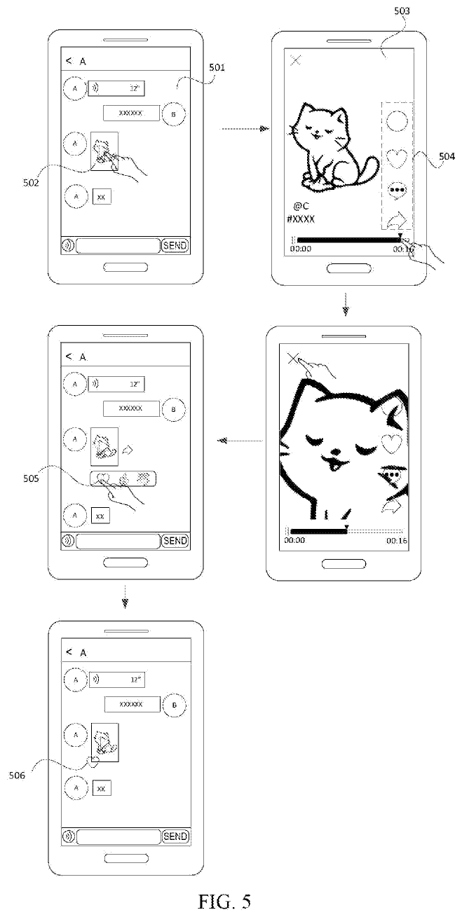

FIG. 5 is a schematic diagram of an interaction process of another message processing method according to an embodiment of the present disclosure. As shown in FIG. 5, user A sends a video message to user B (the current user). The video message is a forwarded video, and is a kitten video published by user C in a predetermined application. In the conversation interface 501, a video cover 502 of the video is displayed and may include a triangular playback logo. As shown in FIG. 5, the video message is not necessarily the most recently received message, and there may be updated messages afterward. The shortcut operation control may not be displayed until user B has tapped to view the video.

At Step 402: a predetermined viewing operation for the video message is received, the video viewing interface is entered, and the video is played.

For example, the video viewing interface may be understood as a detail interface of the video message, and the predetermined viewing operation may be understood as an operation that triggers jumping to the detail interface, which may be, for example, a click on the playback logo. As shown in FIG. 5, after user B clicks on the playback logo, he or she enters the video viewing interface 503, in which the video content in the video message can be played in a full-screen manner. Moreover, information about the video publisher (user C) may be displayed, and an interactive control 504 may be displayed. The interactive control 504 may, for example, include a follow control, a like control, a comment control, and a forward control, etc., so as to facilitate user B to realize interaction with other users through the interactive control 504.

At Step 403: based on the display controlling operation performed by the current user for the video being received on the video viewing interface and based on the interactive operation input to the video, the operation type and/or the operation result of each operation is determined; the playback duration, the number of times of playback, and the played proportion of the video are obtained; and the target data is obtained.

For example, the type of display controlling operation may for example include at least one of pause, playback, and progress adjustment. As shown in FIG. 5, assuming that user B sees that the kitten's expression is cute, but misses the footage and wants to go back to view it again, he or she can realize playback by inputting a progress adjustment operation. The operation result may include data such as the rewinding position and the rewinding length.

For example, user B, in the course of watching the video, if being interested in the video, may also follow user C by triggering the follow control, like the video by triggering the like control, leave a message to user C by triggering the comment control, and so on.

For example, the data such as the operation type and the operation result of each operation, the playback duration of the video, the number of times the video has been played, and the proportion of the video that has been played, and the like are taken as the target data and inputted into the predetermined model, so that the user's attention value for the video message can be determined more reasonably and accurately.

At Step 404: the target data is input into the predetermined model, and the output result of the predetermined model is obtained.

For example, after inputting the target data into the predetermined model, the predetermined model may output an output result for indicating the current user's attention value for the video message.

At Step 405: it is determined whether the attention value is in the predetermined range according to the output result; step 406 is performed if yes; and step 407 is performed if no.

At Step 406: the exit operation is received on the video viewing interface, the conversation interface is returned to, the video cover of the video message is displayed in the conversation interface, and the shortcut operation control corresponding to the video message and associated with the current user is displayed in the association range of the video cover.

For example, if it is determined that the current user has a high attention value for the video message, it can be shown that the current user is likely to have a need for a shortcut operation on the video message. Therefore, while displaying the video cover, shortcut operation controls associated with the current user may be displayed within the association range of the video cover.

As shown in FIG. 5, after user B closes the video viewing interface, he/she returns to the conversation interface. While displaying the video cover 502, three shortcut operation controls are displayed below the video cover 502, all of which are shortcut reply emoticon controls frequently used by user B; and a shortcut forwarding control frequently used by user B is also displayed on the right side of the video cover 502.

At Step 407: a trigger operation for the target shortcut emoticon control is received, and the video cover is displayed in the conversation interface in association with the emoticon icon corresponding to the target shortcut emoticon control to update the display of the video.

For example, as described in FIG. 5, after user B clicks on the heart control 505, a quick reply to the kitten video can be sent by user A. Further, in the conversation interface, the heart icon 506 is added to the lower-left corner of the video cover to update the display of the video cover, which can reflect the result of the reply in a more intuitive manner, enhance the fun, and improve the interactive experience.

At Step 408: the exit operation is received on the video viewing interface, the conversation interface is returned to, and the video cover of the video message is displayed in the conversation interface.

For example, if user B exits the message viewing interface after entering the message viewing interface and watching it for only 2 seconds, the attention value may be rather low and goes beyond the predetermined range. Thus, there is no need to display the shortcut operation control after exiting the message viewing interface, so as to avoid too much interference to user B and meanwhile save the display space of the conversation interface.

In the message processing method according to embodiments of the present disclosure, while playing a video in a video viewing interface of a video message, following data can be obtained: video viewing data as generated in the process of the video being viewed by a user, data related to display controlling operations for the video, and data related to interaction operations based on video content or video authors. Then, the data and predetermined model are used to determine the user's attention value for the video message. After it is determined that the user is interested, the shortcut operation control associated with the current user is displayed after exiting the video viewing interface, so as to facilitate user to quickly respond to the message or perform related processing; and when it is determined that user's attention value is low, the interference to the user as caused by displaying the shortcut operation control can be avoided, so as to utilize the display space of the conversation interface more reasonably and efficiently. Moreover, when the displayed shortcut operation control includes an emoticon control, the display of the video message can be updated according to the target emoticon control selected by user, so as to improve the interactive effect.

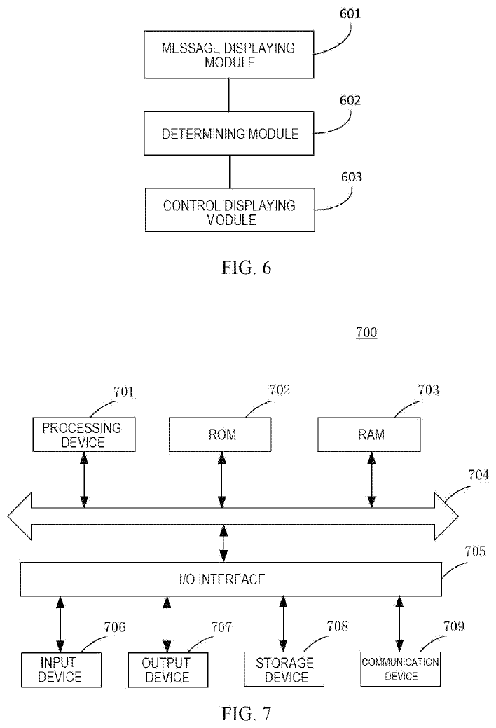

FIG. 6 is a structural block diagram of a message processing apparatus according to embodiments of the present disclosure. The apparatus may be implemented by software and/or hardware, generally may be integrated in an electronic device, and may perform the message processing by executing a message processing method. As shown in FIG. 6, the apparatus includes following modules:
a message displaying module 601, configured to display a received predetermined message in a conversation interface;
a determining module 602, configured to determine whether a predetermined condition is satisfied in response to determining that the current user triggers jumping to a detail interface of the predetermined message and returns to the conversation interface; and
a control displaying module 603, configured to display at least one shortcut operation control corresponding to the predetermined message in the conversation interface if the predetermined condition is satisfied.

For the message processing apparatus according to embodiments of the present disclosure, after displaying the received predetermined message in the conversation interface, if the current user triggers entering the detail interface of the message and returns to the conversation interface, it means that the current user has already viewed the predetermined message. Then, whether it is necessary to display the shortcut operation control is determined based on the predetermined condition, and the shortcut operation control is displayed when necessary, which can provide the user with a message shortcut-processing function, avoid excessive interference to the user by displaying the shortcut operation control by default while displaying the message, and utilize the display space of the conversation interface more reasonably and effectively.

Alternatively, the at least one shortcut operation control includes a shortcut processing control which is configured to process the predetermined message with a predetermined function and/or a shortcut reply control which is configured to reply to the predetermined message.

Alternatively, determining whether the predetermined condition is satisfied includes determining whether the predetermined condition is satisfied based on the target data. The target data herein includes first data and/or second data, the first data includes data as generated by a message content of the predetermined message when the detail interface is viewed by the current user, and the second data includes data corresponding to the message content of the predetermined message.

Alternatively, determining whether the predetermined condition is satisfied based on the target data includes: inputting the target data into the predetermined model. The predetermined model herein is configured to determine the current user's attention value for the predetermined message; determining whether the attention value is in a predetermined range based on an output result of the predetermined model; and if it is, determining that the predetermined condition is satisfied.

Alternatively, the message type of the predetermined message includes a picture and/or a video.

Alternatively, the first data includes at least one of following items: a display duration, a number of times of display and a displayed proportion of the message content of the predetermined message on the detail interface; an operation type and/or an operation result of a display controlling operation performed by the current user on the detail interface to the message content of the predetermined message; and an operation type and/or an operation result of an interactive operation performed by the current user based on the message content of the predetermined message on the detail interface.

Alternatively, the message type of the predetermined message includes a picture, and an operation type of the display controlling operation includes at least one of zooming in, zooming out, and dragging.

Alternatively, the message type of the predetermined message includes a video, and the operation type of the display controlling operation includes at least one of pause, playback and progress adjustment.

Alternatively, the predetermined message includes interactable content, and the interactive operation based on the message content of the predetermined message includes interactive operations directed to the interactable content and/or a creator of the interactable content.

Alternatively, displaying in the conversation interface at least one shortcut operation control corresponding to the predetermined message includes: displaying in the conversation interface at least one shortcut operation control corresponding to the predetermined message and associated with the current user.

Alternatively, the shortcut reply control includes at least one of an emoticon control, a text control, a picture control, and an audio/video control.

Alternatively, the apparatus further includes: an update module, configured to display, after displaying at least one shortcut operation control corresponding to the predetermined message in the conversation interface, the predetermined message in the conversation interface in association with the emoticon icon corresponding to a target emoticon control for updating the display of the predetermined message, in response to receiving a trigger operation for the target emoticon control.

Alternatively, the second data includes: a target content type corresponding to the message content of the predetermined message, and data generated by historical content matching the target content type in a process of being viewed by the current user.

Alternatively, when the conversation interface is a group conversation interface with a predetermined topic, the target data further includes third data, and the third data includes data generated by the predetermined message in a process of being viewed by a predetermined user within a group, the predetermined user not including the current user.

A reference will be made to FIG. 7 below, and FIG. 7 is a schematic structural diagram of an electronic device 700 suitable for implementing embodiments of the present disclosure. The electronic device according to embodiments of the present disclosure may include, but is not limited to, a mobile terminal such as a mobile telephone, a laptop computer, a digital broadcast receiver, a personal digital assistant (PDA), a PAD (tablet computer), a portable medium player (PMP), an in-vehicle terminal (e.g., in-vehicle navigation terminal) and so forth, and a fixed terminal such as a digital TV, a desktop computer and so forth. The electronic device shown in FIG. 7 is only an example and should not impose any limitation on the functionality and application scope of embodiments of the present disclosure.

As shown in FIG. 7, the electronic device 700 may include a processing device (e.g., a central processor, a graphics processor, etc.) 701 that may perform a variety of appropriate operations and processes based on a program stored in a read-only memory (ROM) 702 or loaded from a storage device 708 into a random access memory (RAM) 703. The RAM 703 further stores various programs and data required for the operation of the electronic device 700. The processing device 701, ROM 702, and RAM 703 are connected to each other via a bus 704. An input/output (I/O)) interface 705 is also connected to the bus 704.

Typically, the following devices may be connected to the I/O interface 705, an input device 706 including, for example, a touch screen, a touch pad, a keyboard, a mouse, a camera, a microphone, an accelerometer, a gyroscope, and the like; an output device 707 including, for example, a liquid crystal display (LCD), a loudspeaker, a vibrator, and the like; a storage device 708 including, for example, a magnetic tape, a hard disk, and the like; and a communication device 709. The communication device 709 may allow the electronic device 700 to communicate wirelessly or wiredly with other devices to exchange data. Although FIG. 7 illustrates the electronic device 700 with various units, it should be understood that it is not required to implement or have all of the illustrated units; and the units may alternatively be implemented or included more or less.

In particular, according to embodiments of the present disclosure, the process described above with reference to the flowchart may be implemented as a computer software program. For example, embodiments of the present disclosure include a computer program product including a computer program carried on a non-transient computer-readable medium, and the computer program includes a program code for performing the method shown in the flowchart. In such an embodiment, the computer program may be downloaded and installed from a network via a communication device 709, or installed from a storage device 708, or installed from a ROM 702. The computer program, when executed by the processing device 701, performs the aforesaid functions as defined in the method according to embodiments of the present disclosure.

It should be noted that the computer-readable medium as stated above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or devices, or any combination thereof. Specific examples of the computer-readable storage medium may include, but are not limited to: an electrical connection with at least one wire, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storing device, a magnetic storing device, or any suitable combination thereof. In the present disclosure, the computer-readable storage medium may be any tangible medium that includes or stores a program, and the program may be used by or used in combination with an instruction executing system, apparatus or device. In addition, in the present disclosure, the computer-readable signal medium may include a data signal propagated in a baseband or as part of a carrier wave that carries a computer-readable program code. The data signals as propagated may take a variety of forms, including but not limited to electromagnetic signals, optical signals, or any suitable combination thereof. The computer-readable signal medium may also be any computer-readable medium other than a computer-readable storage medium and may send, propagate, or transmit the program used by or used in combination with the instruction executing system, apparatus or device. The program code included on the computer-readable medium may be transmitted via any suitable medium, including but not limited to wire, optical cable, radio frequency (RF), and the like, or any suitable combination thereof.

The computer-readable medium may be included in the electronic device described above, or may be present alone and not assembled into the electronic device.

The computer-readable medium carries at least one program that, when the at least one program is executed by the electronic device, causes the electronic device to: display a received predetermined message in a conversation interface; determine whether a predetermined condition is satisfied in a case of determining that the current user triggers jumping to a detail interface of the predetermined message and returns to the conversation interface; and display at least one shortcut operation control corresponding to the predetermined message in the conversation interface in response to a determining result that the predetermined condition is satisfied.

The computer program code for performing the operations of the present disclosure may be written in one or more programming languages or combinations thereof. The programming languages include, but are not limited to, object-oriented programming languages such as Java, Smalltalk, and C++, and conventional procedural programming languages such as the “C” language or the like. The program code may be executed entirely on the user's computer, partially on the user's computer, as a stand-alone software package, partially on the user's computer and partially on a remote computer, or entirely on a remote computer or server. In a case of involving a remote computer, the remote computers can be connected to the user's computer via any kind of network, which includes a local area network (LAN) or wide area network (WAN), or can be connected to an external computer (e.g., the connection as realized via Internet from an Internet service provider).

The flowcharts and block diagrams in the accompanying drawings illustrate the architecture, functionality, and operation as possibly achieved by the system, method, and computer program product according to various embodiments of the present disclosure. At this point, each block in the flowchart or block diagram may represent a module, program segment, or portion of code, and the module, program segment, or portion of code includes at least one executable instruction for implementing a prescribed logical function. It shall also be noted that, in some embodiments as replacements, the functions indicated in the blocks may also occur in an order different from the order indicated in the accompanying drawings. For example, two blocks represented one after the other may actually be executed in substantially parallel, and they may sometimes be executed in the opposite order depending on the function as involved. It shall be noted that each block in the block diagram and/or flowchart and the combination of blocks in the block diagram and/or flowchart may be implemented with a dedicated hardware-based system that performs the specified function or operation, or may be implemented with a combination of dedicated hardware and computer instructions.

The modules described in embodiments of the present disclosure may be implemented either by means of software or by means of hardware. The name of a module does not in some cases constitute a limitation to the module itself. For example, a message displaying module may also be described as “a module for displaying a received predetermined message in a conversation interface”.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

According to at least one embodiment of the present disclosure, a message processing method is provided and includes:
displaying a received predetermined message in a conversation interface;
determining whether a predetermined condition is satisfied in response to determining that the current user triggers jumping to a detail interface of the predetermined message and returns to the conversation interface; and
displaying at least one shortcut operation control corresponding to the predetermined message in the conversation interface in response to a determining result that the predetermined condition is satisfied.

Alternatively, the at least one shortcut operation control includes a shortcut processing control which is configured to process the predetermined message with a predetermined function and/or a shortcut reply control which is configured to reply to the predetermined message.

Alternatively, determining whether the predetermined condition is satisfied includes:
determining whether the predetermined condition is satisfied based on target data, wherein the target data includes first data and/or second data, the first data includes data as generated by a message content of the predetermined message when the detail interface is viewed by the current user, and the second data includes data corresponding to the message content of the predetermined message.

Alternatively, determining whether the predetermined condition is satisfied based on the target data includes:
inputting the target data into a predetermined model, wherein the predetermined model is configured to determine the current user's attention value for the present message; and
determining whether the attention value is in a predetermined range according to an output result of the predetermined model, and determining that the predetermined condition is satisfied if the attention value falls into the predetermined range.

Alternatively, the message type of the predetermined message includes a picture and/or a video.

Alternatively, the first data includes at least one of following items: a display duration, a number of times of display and a displayed proportion of the message content of the predetermined message on the detail interface; an operation type and/or an operation result of a display controlling operation performed by the current user on the detail interface to the message content of the predetermined message; and an operation type and/or an operation result of an interactive operation performed by the current user based on the message content of the predetermined message on the detail interface.

Alternatively, the message type of the predetermined message includes a picture, and an operation type of the display controlling operation includes at least one of zooming in, zooming out, and dragging.

Alternatively, the message type of the predetermined message includes a video, and the operation type of the display controlling operation includes at least one of pause, playback and progress adjustment.

Alternatively, the predetermined message includes interactable content, and the interactive operation based on the message content of the predetermined message includes interactive operations directed to the interactable content and/or a creator of the interactable content.

Alternatively, displaying at least one shortcut operation control corresponding to the predetermined message in the conversation interface includes:
displaying in the conversation interface at least one shortcut operation control corresponding to the predetermined message and associated with the current user.

Alternatively, the shortcut reply control includes at least one of an emoticon control, a text control, a picture control, and an audio/video control.

Alternatively, the second data includes: a target content type corresponding to the message content of the predetermined message, and data generated by historical content matching the target content type in a process of being viewed by the current user.

Alternatively, the conversation interface includes a group conversation interface with a predetermined topic, the target data further includes third data, and the third data includes data generated by the predetermined message in a process of being viewed by a predetermined user within a group, the predetermined user not including the current user.

According to at least one embodiment of the present disclosure, a message processing apparatus is provided and includes:
a message displaying module, configured to display a received predetermined message in a conversation interface;
a determining module, configured to determine whether a predetermined condition is satisfied in response to determining that the current user triggers jumping to a detail interface of the predetermined message and returns to the conversation interface; and
a control displaying module, configured to display at least one shortcut operation control corresponding to the predetermined message in the conversation interface if the predetermined condition is satisfied.

According to at least one embodiment of the present disclosure, an electronic device is provided and includes: a memory, a processor, and a computer program stored on the memory and executable on the processor. The processor, when executing the computer program, implements the message processing method according to any embodiment of the present disclosure.

According to at least one embodiment of the present disclosure, a computer-readable storage medium on which computer programs are stored is provided. The computer programs are executed by a processor to implement the message processing method according to any embodiment of the present disclosure.

In addition, although various operations are depicted in a specific order, it should be understood as requiring such operations to be performed in the specific order shown or in a sequential order. Under given conditions, multi-task processing and parallel processing may be advantageous. Similarly, although details of several specific implementations are included in the foregoing discussion, these details should not be construed as a limitation on a scope of the present disclosure. Some features described in the context of individual implementations may also be implemented in a single embodiment in combination. On the contrary, various features described in the context of a single embodiment may also be implemented in a plurality of embodiments separately or in any suitable sub-combination.

Although the subject matter has been described in a language that is specific to structural features and/or logical operations of the method, it should be understood that the subject matter defined in the appended claims is not limited to the specific features or operations described above. On the contrary, the specific features and operations described above are only forms of examples that implement the claims.

1. A method of message processing, comprising:
displaying a received predetermined message in a conversation interface;
and
in response to interface jumping, displaying at least one shortcut operation control corresponding to the predetermined message in the conversation interface, the interface jumping comprising jumping to a detail page of the predetermined message and returning to the conversation interface, triggered by the current user in the conversation interface.

2. The method according to claim 1, wherein the at least one shortcut operation control comprises at least one of a shortcut processing control or a shortcut reply control, the shortcut processing control is configured to process the predetermined message with a predetermined function, the shortcut reply control is configured to reply to the predetermined message.

3-17. (canceled)

18. The method according to claim 1, further comprising:
determining whether a predetermined condition is satisfied.

19. The method according to claim 18, wherein determining whether the predetermined condition is satisfied comprises:
determining, based on target data, whether the predetermined condition is satisfied, wherein the target data comprises at least one of first data and second data, the first data comprises data generated from a message content of the predetermined message while the detail interface is viewed by the current user, and the second data comprises data corresponding to the message content of the predetermined message.

20. The method according to claim 19, wherein determining, based on the target data, whether the predetermined condition is satisfied comprises:
inputting the target data into a predetermined model, wherein the predetermined model is configured to determine an attention value of the current user for the present message; and
determining, based on an output result of the predetermined model, whether the attention value is in a predetermined range, and in response to a determining result that the attention value falls into the predetermined range, determining that the predetermined condition is satisfied.

21. The method according to claim 1, wherein a message type of the predetermined message comprises at least one of a picture and a video.

22. The method according to claim 19, wherein the first data comprises at least one of: a display duration, a number of times of display and a displayed proportion of the message content of the predetermined message on the detail interface; at least one of an operation type and an operation result of a display controlling operation performed by the current user for the message content of the predetermined message on the detail interface; and at least one of an operation type and an operation result of an interactive operation, performed by the current user, based on the message content of the predetermined message on the detail interface.

23. The method according to claim 22, wherein the message type of the predetermined message comprises a picture, and the operation type of the display controlling operation comprises at least one of zooming in, zooming out, and dragging.

24. The method according to claim 22, wherein the message type of the predetermined message comprises a video, and the operation type of the display controlling operation comprises at least one of pause, playback and progress adjustment.

25. The method according to claim 22, wherein the predetermined message comprises interactable content, and the interactive operation based on the message content of the predetermined message comprises at least one of interactive operations directed to the interactable content and a creator of the interactable content.

26. The method according to claim 1, wherein displaying at least one shortcut operation control corresponding to the predetermined message in the conversation interface comprises:
displaying, in the conversation interface, at least one shortcut operation control corresponding to the predetermined message and associated with the current user.

27. The method according to claim 2, wherein the shortcut reply control comprises at least one of an emoticon control, a text control, a picture control, and an audio/video control.

28. The method according to claim 19, wherein the second data comprises: a target content type corresponding to the message content of the predetermined message, and data generated by historical content matching the target content type in a process of being viewed by the current user.

29. The method according to claim 19, wherein the conversation interface is a group conversation interface with a predetermined topic, and wherein the target data further comprises third data, and the third data comprises data generated while the predetermined message is viewed by a predetermined user within a group, the predetermined user excluding the current user.

30. An electronic device, comprising:
a memory, a processor and a computer program stored in the memory and executable on the processor, the processor, upon executing the computer program, performing:
displaying a received predetermined message in a conversation interface; and
in response to interface jumping, displaying at least one shortcut operation control corresponding to the predetermined message in the conversation interface, the interface jumping comprising jumping to a detail page of the predetermined message and returning to the conversation interface, triggered by the current user in the conversation interface.

31. The electronic device according to claim 30, wherein the at least one shortcut operation control comprises at least one of a shortcut processing control or a shortcut reply control, the shortcut processing control is configured to process the predetermined message with a predetermined function, the shortcut reply control is configured to reply to the predetermined message.

32. The electronic device according to claim 30, further comprising:
determining whether a predetermined condition is satisfied.

33. The electronic device according to claim 32, wherein the processor, upon executing the computer program, further performs:
determining, based on target data, whether the predetermined condition is satisfied, wherein the target data comprises at least one of first data and second data, the first data comprises data generated from a message content of the predetermined message while the detail interface is viewed by the current user, and the second data comprises data corresponding to the message content of the predetermined message.

34. The electronic device according to claim 33, wherein the processor, upon executing the computer program, further performs:
inputting the target data into a predetermined model, wherein the predetermined model is configured to determine an attention value of the current user for the present message; and
determining, based on an output result of the predetermined model, whether the attention value is in a predetermined range, and in response to a determining result that the attention value falls into the predetermined range, determining that the predetermined condition is satisfied.

35. A non-transitory computer-readable storage medium having computer programs stored thereon, the computer programs, upon executed by a processor, performing:
displaying a received predetermined message in a conversation interface; and
in response to interface jumping, displaying at least one shortcut operation control corresponding to the predetermined message in the conversation interface, the interface jumping comprising jumping to a detail page of the predetermined message and returning to the conversation interface, triggered by the current user in the conversation interface.
